(19) United States
(12) Patent Application Publication
(10) Pub. No.: US 2025/0263085 A1
(43) Pub. Date: Aug. 21, 2025

(54) METHOD FOR DETERMINING A PERFORMANCE DISCREPANCY BETWEEN A TARGET PERFORMANCE AND AN ACTUAL PERFORMANCE OF A VEHICLE ACTUATOR

(71) Applicant: ZF CV Systems Global GmbH, Bern (CH)

(72) Inventors: Benjamin Bieber, Wedemark (DE); Jonas Böttcher, Hannover (DE); Klaus Plähn, Seelze (DE); Oliver Wulf, Neustadt (DE)

(21) Appl. No.: 19/204,338

(22) Filed: May 9, 2025

Related U.S. Application Data
(63) Continuation of application No. PCT/EP2023/083323, filed on Nov. 28, 2023.

(30) Foreign Application Priority Data
Dec. 20, 2022 (DE) 10 2022 134 144.5

(51) Int. Cl. B60W 50/04; B60W 50/00; B60W 50/14; B60W 60/00; G07C 5/02

(52) U.S. Cl. CPC B60W 50/045; B60W 50/0097; B60W 50/14; B60W 60/001; G07C 5/02; B60W 2510/06; B60W 2510/18; B60W 2510/20; B60W 2510/205; B60W 2520/105; B60W 2520/14

(57) ABSTRACT

A method is for determining a performance discrepancy of a vehicle actuator and includes determining a target degree of freedom of movement value; determining an expected manipulated variable value; determining an actual degree of freedom of movement value; determining an actual manipulated variable value; and obtaining a maximum manipulated variable value. The method includes determining the performance discrepancy of the vehicle actuator using the actual degree of freedom of movement value, the target degree of freedom of movement value, the actual manipulated variable value, the expected manipulated variable value, and the maximum manipulated variable value; and, determining an updated maximum degree of freedom of movement value of the vehicle based on the determined performance discrepancy. An actuator monitoring system is for monitoring a performance characteristic of a vehicle actuator configured to influence at least one degree of freedom of movement of a vehicle. A vehicle has the actuator monitoring system.

### CROSS-REFERENCE TO RELATED APPLICATIONS

This application is a continuation application of international patent application PCT/EP2023/083323, filed Nov. 28, 2023, designating the United States and claiming priority from German application 10 2022 134 144.5, filed Dec. 20, 2022, and the entire content of both applications is incorporated herein by reference.

### TECHNICAL FIELD

The disclosure relates to methods for determining a performance discrepancy between a target performance and an actual performance of a vehicle actuator of a vehicle, wherein the vehicle actuator is configured to influence at least one degree of freedom of movement of a vehicle. Furthermore, the disclosure relates to an actuator monitoring system and to a vehicle having an actuator monitoring system.

### BACKGROUND

Vehicles have a large number of vehicle actuators which act on degrees of freedom of movement of the vehicle or serve to influence the degrees of freedom of movement of the vehicle. Thus, for example, a drive engine of a vehicle generally serves to accelerate the vehicle or to keep a speed of the vehicle constant counter to acting resistances, in particular air resistance and frictional resistance of the vehicle. Further examples of vehicle actuators are a brake system of the vehicle, which is provided to decelerate the vehicle, and a steering system of the vehicle. The vehicle actuators generally influence the degrees of freedom of movement of the vehicle over a certain period of time and, for this purpose, have to deliver a performance in this period of time. Thus, the drive performance, usually given in kW or horse power, of a drive engine is a common variable for vehicles. However, other vehicle actuators also deliver a performance. Thus, the brake system of the vehicle has, for example, to provide a brake performance in order to reduce the speed of the vehicle.

On account of different influences, the performance of a vehicle actuator can be limited. Thus, a drive performance of a drive engine can be reduced, for example, on account of failure of a cylinder of the drive engine, on account of poor lubrication and/or on account of wear. The performance of brakes of the vehicle can also be temporarily or permanently limited. Thus, brakes of a vehicle can be excessively loaded and heat up significantly on long downhill sections. At temperatures of 400° C. or more, the brake performance of conventional friction brakes generally declines and a brake performance that is able to be provided by the brake is reduced. This phenomenon is also referred to as fading. If a vehicle actuator is unable, in the actual state, to deliver a performance which the vehicle actuator is intended to provide, there is then a performance discrepancy between an actual performance and a target performance. This performance discrepancy may be safety-critical in particular when braking or steering the vehicle. Thus, it is possible, for example, for brake disks of a brake system of the vehicle to be slightly rusty after a relatively long standing time, with the result that the brake performance that is able to be provided by the brake system is reduced. However, under certain circumstances, a driver of the vehicle may be unaware of this performance discrepancy, and so they could control the vehicle inadequately. If a brake performance that is unable to be provided by the brake system is then demanded, this may result in accidents.

### SUMMARY

It is an object of the disclosure to provide a method that allows a performance discrepancy of the vehicle to be determined and affords increased safety. The disclosure also addresses the problem of specifying an actuator monitoring system and a vehicle which afford increased safety.

In a first aspect, the disclosure solves this problem with a method of the type mentioned at the beginning, which has the following steps: determining a target degree of freedom of movement value for the vehicle; determining an expected manipulated variable value for achieving the target degree of freedom of movement value; determining an actual degree of freedom of movement value for the vehicle, which corresponds to the target degree of freedom of movement value; determining an actual manipulated variable value, which is provided at the vehicle actuator for achieving the actual degree of freedom of movement value; obtaining a maximum manipulated variable value of the vehicle actuator; and determining the performance discrepancy of the vehicle actuator if the actual degree of freedom of movement value lies outside a degree of freedom of movement tolerance around the target degree of freedom of movement value and the actual manipulated variable value is lower than the maximum manipulated variable value; the actual degree of freedom of movement value lies outside a degree of freedom of movement tolerance around the target degree of freedom of movement value, the expected manipulated variable value corresponds to the maximum manipulated variable value, and the actual manipulated variable value corresponds to the maximum manipulated variable value, or if the actual degree of freedom of movement value corresponds to the target degree of freedom of movement value and the actual manipulated variable value required for achieving the actual degree of freedom of movement value lies outside a manipulated variable tolerance around the expected manipulated variable value. The method preferably also involves: determining an updated maximum degree of freedom of movement value of the vehicle on the basis of the determined performance discrepancy.

The performance discrepancy does not necessarily have to be a variable that corresponds to a physical performance with the unit watts. Thus, the performance discrepancy can also be by a discrepancy of a force that is able to be provided by the vehicle actuator, for example a brake force, a torque that is able to be provided by the vehicle actuator, a current that is able to be provided by the vehicle actuator, a voltage that is able to be provided by the vehicle actuator, and/or an angle that is able to be provided by the vehicle actuator, in particular a steering angle. Thus, it is possible, for example, for a performance discrepancy of a brake of the vehicle also to be identifiable in that the brake system or a brake of the brake system provides an actual brake force that is less than a target brake force. The lower brake force then also brings about a lower brake performance.

Via the method according to the disclosure, a performance discrepancy, that is, a deviation between an expected performance (target performance) of the vehicle actuator and a real performance (actual performance), can be determined in at least two ways depending on the situation. If the target value of the degree of freedom of movement (target degree of freedom of movement value) is not achieved or if it differs from the actual degree of freedom of movement value, a deviation is determined, if the expected manipulated variable value and target manipulated variable value correspond to the maximum manipulated variable value. If, for example, in spite of the specification of a maximum brake pressure of 10 bar, a deceleration of the vehicle of only 5 m/s² is achieved (actual degree of freedom of movement value=5 m/s²), even though the target value for the maximum brake pressure is 7 m/s² (target degree of freedom of movement value=7 m/s²), this is an indicator that a brake system of the vehicle (the vehicle actuator) cannot provide the desired deceleration (that is, that there is a performance discrepancy of the brake system). The same goes when the target degree of freedom of movement value cannot be achieved even though the actual manipulated variable does not correspond to the maximum manipulated variable value. This is the case, for example, when, rather than a maximum manipulated variable value of 10 bar, only an actual manipulated variable value of 7 bar can be provided at one or more brakes of the brake system on account of damage, a predetermined brake pressure limitation and/or thermal overload.

In the second variant, the actual degree of freedom of movement value corresponds to the target degree of freedom of movement value. Thus, for example, a desired deceleration of the vehicle of 3 m/s² is achieved. However, to achieve this deceleration, an actual manipulated variable value that is greater than an expected manipulated variable value is required. In the above-described example, rather than a predicted brake pressure (expected manipulated variable value) of 4 bar, an actual brake pressure of 6 bar (actual manipulated variable value) has to be provided in order to achieve the desired target deceleration. This may be, for example, because one or more brake disks of the brake system are slightly rusty after a long standing time, or because brake pads have vitrified on account of a prior high thermal load. It is also possible to conclude, from the deviation of the actual manipulated variable value and the expected manipulated variable value, that the performance of the vehicle actuator (the brake in the present example) does not correspond to an expected performance.

The target degree of freedom of movement value is a target value of the degree of freedom of movement that is demanded for the vehicle by a human driver or by a (partially) autonomous unit, also referred to as a virtual driver. The degree of freedom of movement is preferably a change in the longitudinal dynamics of the vehicle, that is, a longitudinal acceleration or longitudinal deceleration of the vehicle. The target degree of freedom of movement value is then, for example, a deceleration of the vehicle, demanded by the driver or by an autonomous unit, of, for example, 2 m/s². The actual degree of freedom of movement value is related to the target degree of freedom of movement value such that the actual degree of freedom of movement value and the target degree of freedom of movement value describe the degree of freedom of movement of the same driving situation. The actual degree of freedom of movement value and target degree of freedom of movement value always relate to the same degree of freedom of movement.

The expected manipulated variable value for the vehicle actuator is preferably predicted as part of the method. This means that a prediction is made as to which manipulated variable needs to be provided at the vehicle actuator in order to achieve the target value of the degree of freedom of movement. In the method, an expected manipulated variable value is determined, wherein the expected manipulated variable value specifies which value of the manipulated variable needs to be provided at the vehicle actuator according to a prediction, in order to achieve the target degree of freedom of movement value. Preferably, the prediction is made on the basis of and/or using learned driving data of the vehicle. For example, the expected manipulated variable value may be an actual manipulated variable value which has been provided at the vehicle actuator for a comparable or identical vehicle configuration and has resulted in an actual degree of freedom of movement value that corresponds to or is comparable to the target degree of freedom of movement value. Alternatively or additionally, the prediction can also be made on the basis of and/or using a vehicle model. The expected manipulated variable value is a value of the manipulated variable which is intended to be provided at the vehicle actuator according to a prediction or forecast in order to achieve the target degree of freedom of movement value.

The degree of freedom of movement tolerance is intended to compensate for slight fluctuations in the actual value, which may result, for example, from measurement inaccuracies. Preferably, the degree of freedom of movement tolerance amounts to more than 0% to 20%, particularly preferably 3% to 5% of a maximum degree of freedom of movement value. Thus, for example, the degree of freedom of movement tolerance may be 5% of a maximum achievable deceleration of the vehicle. This means that, for example, an actual degree of freedom of movement value with a value that deviates from the target degree of freedom of movement value by more than 5% of the maximum degree of freedom of movement value no longer lies within the degree of freedom of movement tolerance. Preferably, the degree of freedom of movement tolerance is defined depending on the degree of freedom of movement in question. Thus, the degree of freedom of movement tolerance may have a relatively large value when the degree of freedom of movement is a longitudinal deceleration of the vehicle, and may have a relatively small value when the degree of freedom of movement is a lateral acceleration and/or yaw rate of the vehicle.

In various embodiments, the degree of freedom of movement tolerance and/or the manipulated variable tolerance have a predefined value. Also preferably, the degree of freedom of movement tolerance and/or the manipulated variable tolerance may also be learned tolerances and/or dynamic tolerances. A tolerance with a predefined value may be determined, for example, from a specification of vehicle components, in particular sensors for sensing the actual manipulated variable value and/or the actual degree of freedom of movement value. Thus, for example, a load cell may have a resolution and a latency with which the measured signal is made available at the interface thereof. This latency may be used to define the manipulated variable tolerance. A learned tolerance may be learned, for example, from comparative values of previous comparable driving situations (substantially identical loading of the vehicle, identical weather conditions and/or identical gradient of the roadway) and/or from comparative values that are determined in road tests. If, for example, a vehicle deceleration at a brake pressure of 8 bar led to decelerations of 7.9 m/s² to 8.1 m/s² in past driving situations, a degree of freedom of movement tolerance of 0.2 m/s² can be learned from these historical driving data.

The determining of the updated maximum degree of freedom of movement value of the vehicle on the basis of the determined performance discrepancy can allow conclusions to be drawn about the vehicle. Thus, if there is a performance discrepancy of the brake system or of one or more brakes of the vehicle, a maximum achievable vehicle deceleration can be determined. If, for example, in a normal situation without a performance discrepancy, a brake performance of 400 kW is able to be provided via the brake system, but a relative performance discrepancy of 50% has been determined, then an updated maximum vehicle deceleration of only 5 m/s² can be determined as the updated maximum degree of freedom of movement value rather than an undisturbed maximum vehicle deceleration of 10 m/s².

In a first embodiment of the method, the determining of the performance discrepancy of the vehicle actuator takes place only if the actual degree of freedom of movement value lies outside a degree of freedom of movement tolerance around the target degree of freedom of movement value for at least a discrepancy time, or if the actual manipulated variable value required for achieving the target degree of freedom of movement value lies outside a manipulated variable tolerance around the expected manipulated variable value for at least the discrepancy time. Preferably, the discrepancy time has a value of 0.5 s or more, preferably 1 s or more, preferably 1.5 s or more, particularly preferably 2 s. According to the preferred development, a performance discrepancy and/or the updated maximum degree of freedom of movement value is determined only when the target/actual deviation of the degree of freedom of movement or the target/actual deviation of the manipulated variable deviates from the associated tolerance for at least the discrepancy time. Thus, it is possible to ensure that tiny deviations that may result, for example, from measurement inaccuracies, do not already result in the determining of the performance discrepancy. Robustness of the method with respect to erroneous determinations is improved. Preferably, the determining of the performance discrepancy is carried out continuously, but the determining of an updated degree of freedom of movement is carried out only when the actual degree of freedom of movement value lies outside the degree of freedom of movement tolerance for at least the discrepancy time and/or when the actual manipulated variable value lies outside the manipulated variable tolerance for at least the discrepancy time.

In various embodiments, the determining of a target degree of freedom of movement value includes: determining a planned trajectory for the vehicle, via an autonomous unit; and determining the target degree of freedom of movement value from the trajectory. The trajectory includes at least one planned route (target route) that is to be driven along by the vehicle in order to fulfill a driving task. Furthermore, the trajectory includes a vehicle dynamic specification. This vehicle dynamic specification is or includes preferably a predefined speed for driving along the route or a predefined speed profile for driving along the route. Thus, it is possible to determine, for example, from an actual speed of the vehicle and from a predefined speed included by the trajectory, a target deceleration of the vehicle which is necessary to decelerate the vehicle from an actual speed to the predefined speed. The autonomous unit may be a fully autonomous or partially autonomous unit of the vehicle. An autonomous unit is preferably a virtual driver of the vehicle, which is configured to autonomously control the vehicle. The autonomous unit may, however, also be a unit, in particular a control unit, of a driver assistance system, in particular of automatic distance control. Alternatively or additionally, the obtaining of a target degree of freedom of movement value includes: determining a travel of an actuating device; and determining the target degree of freedom of movement value on the basis of the determined travel. Thus, it is possible, for example, to determine a travel of an actuating device in the form of a brake pedal and to convert this travel into a target deceleration using a known pedal characteristic.

In various embodiments, the method also includes the step of: determining a vehicle dynamics limit value for the vehicle using the determined performance discrepancy, if a performance discrepancy of the vehicle actuator is determined. Compliance with the vehicle dynamics limit value ensures, in regular operation, a safe and stable journey of the vehicle. Preferably, the vehicle dynamics limit value is or includes a maximum permissible vehicle speed, a maximum permissible lateral acceleration, a maximum permissible vehicle acceleration, a maximum permissible vehicle deceleration, a maximum permissible steering angle gradient, a maximum permissible steering frequency, or a minimum permissible cornering radius of the vehicle. Via the method according to the disclosure, it is also possible for a plurality of vehicle dynamics limit values to be defined for the vehicle, such that, for example, a maximum permissible vehicle speed is defined as a first vehicle dynamics limit value and a maximum permissible lateral acceleration is defined as a second vehicle dynamics limit value. If, for example, a performance discrepancy of a driving brake is determined, the brake performance that is able to be provided by this driving brake can be reduced compared with a brake performance as a general rule. The vehicle is then not able to be decelerated with full power, and this can be taken into consideration by setting a vehicle dynamics limit value. Thus, it is possible, for example, for a vehicle deceleration of the vehicle that is able to be demanded at a maximum by a driver to be limited by a vehicle dynamics limit value. A driver can take this limitation into account when planning a start of braking and/or when estimating the braking distance. Analogously, it is also possible, for example, to limit a demandable steering angle speed.

According to various embodiments, the method also involves: redetermining the planned trajectory using the determined vehicle dynamics limit value. The redetermining of the planned trajectory may be complete redetermining of the planned trajectory, partial redetermining of the planned trajectory, and/or updating of the planned trajectory. Particular redetermining exists, for example, when a path included by the planned trajectory is maintained and, at the same time, a corresponding speed profile for driving along the path, the speed profile being included by the planned trajectory, is redetermined. In the case of partial redetermining, preferably all of the information and/or data underlying the trajectory planning is/are redetermined. In the case of updating, preferably only some of the information and/or data underlying the trajectory planning is/are redetermined. The determined vehicle dynamics limit value is thus taken into consideration in the trajectory, with the result that safety when using the vehicle can be increased.

In various embodiments, the determining of an expected manipulated variable value of the vehicle actuator for achieving the target degree of freedom of movement value takes place using learned actual manipulated variable values for learned target degree of freedom of movement values which lie in a degree of freedom of movement tolerance band around the target degree of freedom of movement value. The expected manipulated variable value is a forecast of the manipulated variable which has to be predefined in order to achieve the target degree of freedom of movement value. This forecast can be carried out particularly easily using learned actual manipulated variable values which have been predefined for comparable target degree of freedom of movement values. Comparable target degree of freedom of movement values are learned target degree of freedom of movement values, the value of which lies in a degree of freedom of movement tolerance band that has a width of at most 10%, preferably at most 5%, preferably at most 3%, preferably at most 2%, particularly preferably at most 1.5%, around the value of the corresponding target degree of freedom of movement value. For example, an expected value for a brake pressure (manipulated variable) that has to be set to achieve a deceleration of the vehicle by 2 m/s² can be determined on the basis of learned brake pressures which have resulted in a deceleration of the vehicle in a range from 1.8 m/s² to 2.2 m/s². Alternatively or additionally, the required brake pressure, which is required for a target deceleration, is determined preferably from parameters of an electronic brake system of the vehicle when the degree of freedom of movement is or includes a deceleration.

According to various embodiments, the determining of an expected manipulated variable value of the vehicle actuator for achieving the target degree of freedom of movement value includes: determining environmental data of the vehicle, and determining the expected manipulated variable value using the environmental data. As a result of the use of environmental data, accuracy of the determined expected manipulated variable value can be improved. Thus, a discrepancy between a target degree of freedom of movement value and an actual degree of freedom of movement value can be based entirely or partially on influencing factors which are independent of the vehicle actuator. Thus, it is possible, for example, for a deceleration achieved when braking the vehicle to be lower than an expected target deceleration when the vehicle is driving on an icy roadway. As a result of the use of environmental data, this circumstance can be taken into account, for example in that the target degree of freedom of movement value is reduced. The environmental data are or include preferably weather data, but may also be or include other environmental data, for example data about the quality of the road surface.

In various embodiments, the determining of an expected manipulated variable value of the vehicle actuator for achieving the target degree of freedom of movement value includes: determining vehicle data of a current vehicle configuration of the vehicle, and determining the expected manipulated variable value using the vehicle data. The current vehicle configuration relates both to vehicle-specific aspects and to load-specific aspects. Besides the geometric characteristics of the vehicle, the current vehicle configuration also includes load characteristics. The load characteristics represent loads acting on the vehicle, which may result, for example, from the unladen weight of the vehicle and from a load of the vehicle. Thus, a current vehicle configuration of an unladen vehicle is different than a current vehicle configuration of the same vehicle in a loaded state. A load characteristic may be or include preferably a wheel load, an axle load, a vehicle total mass, a mass of a vehicle part and/or a center of gravity of the vehicle or of a vehicle part. Also preferably, the load characteristics may also include data that represent a wheel load, an axle load, a vehicle total mass and/or a mass of a vehicle part. The current vehicle configuration has a significant influence on the movement behavior of the vehicle (or on its degrees of freedom of movement), and so accuracy of the determined expected manipulated variable value can be improved when the vehicle data of the current vehicle configuration are taken into account. It should be understood, however, that the use of the vehicle data when determining the expected manipulated variable value is not essential to the disclosure.

In various embodiments, the determining of the expected manipulated variable value using the vehicle data includes: predicting a dynamic behavior of the vehicle using the vehicle data; and determining the expected manipulated variable value on the basis of the predicted dynamic behavior of the vehicle. The predicting of the dynamic properties of the current vehicle configuration takes place preferably on the basis of a model. Thus, a behavior of the vehicle is predictable. In a preferred refinement, a vehicle model used to predict the dynamic behavior of the vehicle is a single-track model of the vehicle.

Preferably, the degree of freedom of movement is or includes a longitudinal acceleration of the vehicle, a longitudinal deceleration of the vehicle, a maximum curvature of a path that the vehicle can maximally drive along, a steering angle speed of the vehicle, a steering angle of the vehicle, a braking distance of the vehicle, or a yaw speed of the vehicle. Preferably, the degree of freedom of movement may also be or include a yaw rate and/or a yaw speed.

Preferably, the vehicle actuator is or includes an active steering system, a brake system, a parking brake, a sustained-action brake, a driving brake, a wheel locking mechanism, an additional steering system, an internal combustion engine and/or an electric motor of the vehicle. However, provision may also be made for the method to be carried out for a plurality of vehicle actuators of the vehicle, for example for a driving brake and an active steering system at the same time.

According to various embodiments, the determining of the performance discrepancy takes place entirely or at least partially via a brake system of the vehicle. This is advantageous in particular when the vehicle actuator is a brake system or a brake of the vehicle. However, provision may also be made for the brake system to determine a performance discrepancy of a vehicle actuator that is not associated with the brake system, for example of a steering system. Preferably, the determining of the performance discrepancy takes place entirely or partially via a brake control unit of the brake system.

Preferably, the method also includes: providing a warning signal if a performance discrepancy of the vehicle actuator is determined. The warning signal is provided preferably via a human-machine interface. The warning signal is preferably a visual, acoustic, haptic and/or electronic warning signal. An electronic warning signal may be provided for example to an autonomous unit of the vehicle, in particular to the virtual driver. The human-machine interface is preferably a warning light, a loudspeaker and/or a screen.

In a preferred refinement, the target degree of freedom of movement value is determined on the basis of vehicle onboard data. Vehicle onboard data are data that are determined by a vehicle system or a unit of the vehicle, wherein such determining does not involve receiving external data. External data are, for example, data that are transmitted to the vehicle via a transmitting antenna and are received by an antenna of the vehicle. As a result of the use of vehicle onboard data when determining the target degree of freedom of movement value, this determining can take place independently of external units that do not belong to the vehicle. Preferably, vehicle onboard data are provided by vehicle subsystems of the vehicle. For example, signals from a brake control unit of the vehicle may be such vehicle onboard data. Vehicle onboard data relate preferably to the vehicle itself. Vehicle onboard data are particularly preferably not route data and/or map data and/or digital maps.

In a second aspect, the disclosure solves the problem mentioned at the beginning with an actuator monitoring system for monitoring a performance characteristic of a vehicle actuator which is configured to influence at least one degree of freedom of movement of a vehicle, the actuator monitoring system having a state signal receiving unit which is connectable to a network of the vehicle in order to receive state signals that represent an actual degree of freedom of movement value of the vehicle, and which is connectable to the vehicle actuator in order to receive an actual manipulated variable value, a target degree of freedom of movement value determining unit which is configured to determine a target degree of freedom of movement value for the vehicle and an expected manipulated variable value of the vehicle actuator for achieving the target degree of freedom of movement value, and a performance discrepancy determining unit which is configured to determine a performance discrepancy of the vehicle actuator if the actual degree of freedom of movement value lies outside a degree of freedom of movement tolerance around the target degree of freedom of movement value and the actual manipulated variable value is lower than the maximum manipulated variable value; the actual degree of freedom of movement value lies outside a degree of freedom of movement tolerance around the target degree of freedom of movement value, the expected manipulated variable value corresponds to the maximum manipulated variable value, and the actual manipulated variable value corresponds to the maximum manipulated variable value, or if the actual degree of freedom of movement value corresponds to the target degree of freedom of movement value and the actual manipulated variable value required for achieving the actual degree of freedom of movement value lies outside a manipulated variable tolerance around the expected manipulated variable value. Furthermore, the performance discrepancy determining unit is preferably configured to determine an updated maximum degree of freedom of movement value of the vehicle on the basis of the determined performance discrepancy.

Preferably, the state signal receiving unit, the target degree of freedom of movement value determining unit and/or the performance discrepancy determining unit are components of a control unit. In a preferred refinement, the control unit of the actuator monitoring system is a brake control unit of a brake system of the vehicle. Preferably, the actuator monitoring system also has an interface for outputting a warning signal, wherein the control unit is configured to output the warning signal via the interface if a performance discrepancy of the vehicle actuator is determined. The interface may also be connectable to a control unit of the vehicle, which is configured to control the vehicle actuator, in order to receive an actual manipulated variable value.

It should be understood that the actuator monitoring system according to the second aspect of the disclosure may have the same subaspects as or similar to various embodiments of the method according to the first aspect of the disclosure. Thus, for example, the performance discrepancy determining unit may be configured to determine the performance discrepancy only if the actual degree of freedom of movement value lies outside a degree of freedom of movement tolerance around the target degree of freedom of movement value for at least a discrepancy time, or if the actual manipulated variable value required for achieving the target degree of freedom of movement value lies outside the manipulated variable tolerance around the expected manipulated variable value for at least the discrepancy time.

Preferably, the disclosure solves the problem mentioned at the beginning with an actuator monitoring system which is configured to carry out the method according to the first aspect of the disclosure. Preferably, the actuator monitoring system has a control unit which is connectable to a network of the vehicle in order to receive state signals that represent an actual degree of freedom of movement value of the vehicle, and which is connectable to the vehicle actuator in order to receive an actual manipulated variable value, wherein the control unit is configured to carry out the method according to the first aspect of the disclosure.

In a third aspect, the problem mentioned at the beginning is solved by a vehicle having one or more vehicle actuators, at least one network, and an actuator monitoring system according to the second aspect of the disclosure. Preferably, the vehicle is a commercial vehicle. A commercial vehicle is a motor vehicle which is intended, depending on its configuration and setup, to transport persons or goods, or to tow trailers, but is not a passenger car or motorcycle, but rather, for example, a bus, a truck, a tractor or a crane truck. In the scope of the present disclosure, the commercial vehicle may be a simple commercial vehicle, also frequently referred to as a rigid vehicle, or a vehicle train consisting of a towing vehicle and one or more trailer vehicles. A typical example of a vehicle train includes a tractor unit and a semitrailer.

Preferably, the vehicle has a brake system. Particularly preferably, the brake system is a pneumatic brake system. The brake system includes preferably one or more spring-loaded brakes, a trailer control module and/or an electronic parking brake.

It should be understood that the vehicle according to the third aspect of the disclosure may have the same subaspects as or similar ones to various embodiments of the method according to the first aspect of the disclosure.

### BRIEF DESCRIPTION OF DRAWINGS

The invention will now be described with reference to the drawings wherein:

FIG. 1 shows a plan view of a schematically illustrated vehicle;

FIG. 2A shows a schematic flowchart of a first embodiment of a method for determining a performance discrepancy;

FIG. 2B shows a schematic flowchart of a second embodiment of a method for determining a performance discrepancy;

FIG. 2C shows a schematic flowchart of a third embodiment of a method for determining a performance discrepancy;

FIG. 3 shows a detailed flowchart for determining a target degree of freedom of movement value; and,

FIG. 4 shows a detailed flowchart for determining an expected manipulated variable value.

### DETAILED DESCRIPTION

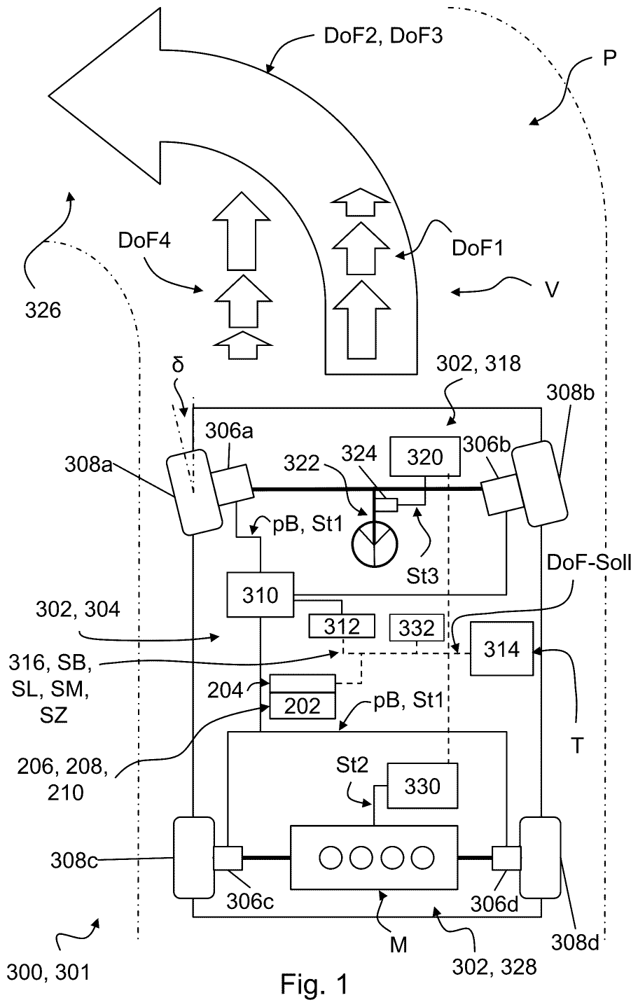

FIG. 1 shows a vehicle 300 which has a plurality of vehicle actuators 302. The vehicle actuators 302 are configured to influence the longitudinal dynamics and transverse dynamics of the vehicle 300. In this regard, the vehicle actuators 302 influence a plurality of degrees of freedom of movement DoF of the vehicle 300. To decelerate the vehicle 300, a brake system 304 of the vehicle 300 includes a plurality of brake cylinders 306 that are assigned to wheels 308 of the vehicle 300. In the present embodiment, the brake cylinders 306 cooperate to decelerate the vehicle 300. The brake system 304 thus forms a first vehicle actuator 302. Provision may also be made, however, for individual brake cylinders 306 to form a vehicle actuator 302 individually and/or in subgroups.

In order to achieve longitudinal deceleration DoF1 of the vehicle 300, this being a first degree of freedom of movement DoF of the vehicle 300, a brake modulator 310 of the brake system 304 provides a brake pressure pB at the brake cylinders 306. Thereupon, the brake cylinders 306 close and thus set a brake slip at the wheels 308 of the vehicle 300, this bringing about the longitudinal deceleration DoF1. The longitudinal deceleration DoF1 is illustrated in FIG. 1 via arrows, the length of which decreases. The level of the brake pressure pB set by the brake modulator 310 of the brake system 304 for the different brake cylinders 306 is determined by a brake control unit 312 of the brake system 304, which controls the brake modulator 310. Thus, the brake control unit 312 can control the brake modulator 310 for example such that it sets a higher brake pressure pB at brake cylinders 306a, 306b assigned to front wheels 308a, 308b of the vehicle 300 than at brake cylinders 306c, 306d that are assigned to rear wheels 308c, 308d of the vehicle 300. However, provision may also be made for the brake pressure pB to be set individually for each wheel or in an identical manner for all the wheels 308. The brake pressure pB or brake pressures pB are in this case manipulated variables St of the vehicle actuator 302 formed by the brake system 304.

The brake control unit 312 of the brake system 304 is connected to an autonomous unit 314 of the vehicle 300, which may also be referred to as virtual driver 314. The virtual driver 314 is intended to autonomously control the vehicle 300 such that the vehicle 300 can be driven without a human driver. The virtual driver 314 is configured to plan a trajectory T for the vehicle 300, which includes a planned path P for the vehicle 300 and a speed profile corresponding to the path P. The speed profile defines, for each point on the path P, an associated speed. However, provision may also be made for the speed profile to define an associated speed in each case only for spaced-apart points on the path P.

The brake control unit 312 of the brake system 304 and the virtual driver 314 are connected via a vehicle network 316, which in this case is a CAN bus system of the vehicle 300. The virtual driver 314 is configured to plan the trajectory T and to carry out position control of the vehicle 300. In the embodiment shown, the virtual driver 314 is thus also a position control unit of the vehicle 300. However, in other embodiments, provision may also be made for the position control unit to be a unit other than the virtual driver 314 intended to plan the trajectory T. While the vehicle 300 is moving along the path P, the virtual driver 314 actuates the brake system 304 in order to guide the vehicle 300 along the path P as far as possible with the speed V corresponding to the speed profile. For this purpose, the virtual driver 314 provides brake control signals SB on the vehicle network 316, which are then received by the brake control unit 312. The brake control unit 312 then controls the brake modulator 310 or the brake cylinders 306 in accordance with the brake control signals SB.

As a further vehicle actuator 302, the vehicle 300 has an electronically controllable steering system 318. By way of the steering system 318, a lateral acceleration DoF2 and/or a yaw rate DoF3 of the vehicle 300 can be influenced. The lateral acceleration DoF2 and the yaw rate DoG3 form further degrees of freedom of movement DoF of the vehicle 300. The lateral acceleration DoF2 and the yaw rate DoF3 are indicated in FIG. 1 via an arrow illustrating a cornering maneuver by the vehicle 300.

The electronically controllable steering system 318 has a steering control unit 320 which is connected to the virtual driver 314 via the vehicle network 316. The virtual driver 314 acting as a position control unit provides steering control signals SL to the steering control unit 320 via the vehicle network 316 in order to guide the vehicle 300 along the path P. The steering control unit 320 receives the steering control signals SL and determines therefrom a corresponding manipulated variable St for a servomotor 324, connected to a steering shaft 322, of the electronically controllable steering system 318. The manipulated variable St is in this case a servo current St3 of the servomotor 324. When the servo current St3 is provided, the servomotor 324 turns the steering shaft 322, this in turn causing a steering angle δ to be set at the front wheels 308a, 308b. On account of friction between the front wheels 308a, 308b and a roadway 326 driven along by the vehicle 300, the front wheels 308a, 308b positioned at the steering angle δ build up cornering forces that cause the vehicle 300 to turn. The lateral acceleration DoF2 and the yaw rate DoF3 correspond to this turning and to the speed V of the vehicle 300.

The vehicle 300 also includes an engine 328 which drives the rear wheels 308c, 308d of the vehicle 300. Via a drive torque M provided at the rear wheels 308c, 308d by the engine 328, a longitudinal acceleration DoF4 of the vehicle 300 can be brought about. Analogously to the longitudinal deceleration DoF1, the longitudinal acceleration DoF4 is also illustrated in FIG. 1 via arrows of changing length, wherein the length of the arrows increases during the longitudinal acceleration DoF4, this being intended to indicate an increasing speed V of the vehicle 300. An engine control device 330 of the engine 328 is likewise connected to the virtual driver 314 via the vehicle network 316. In order to accelerate the vehicle 300, the virtual driver 314 provides engine control signals SM on the vehicle network 316, which are then received by the engine control device 330. The engine control device 330 provides a manipulated variable St corresponding to the engine control signals SM, this being, for example, an injection quantity St2 of fuel injected into cylinders of the engine 328.

While the vehicle 300 is traveling on the path P, the virtual driver 314, in its function as a position control unit, as far as possible always selects the engine control signals SM such that the drive torque M corresponds to a desired longitudinal acceleration DoF4 of the vehicle 300. Analogously, the virtual driver 314 tries, via the steering signals SL which are provided at the electronically controllable steering system 318 via the vehicle network 314, to keep the vehicle 300 on the path P. For this purpose, the steering system 318, where possible, sets the lateral acceleration DoF2 desired by the virtual driver 314 and/or the desired yaw rate DoF4 of the vehicle 300. Analogously, the virtual driver 314, in its function as a position control unit, selects the brake control signals SB as far as possible such that a longitudinal deceleration DoF1, corresponding to the trajectory T, of the vehicle 300 is achieved. Before or while the vehicle 300 is still carrying out a movement, pre-planned target values for the degrees of freedom of movement DoF (target degree of freedom of movement values DoF-Soll) longitudinal deceleration DoF1, lateral acceleration DoF2, yaw rate DoF3, and longitudinal acceleration DoF4 are present at the virtual driver 314. These are determined by the virtual driver 314 as part of planning the trajectory T. In the present embodiment, a target longitudinal deceleration value DoF1-Soll has a value of 8 m/s².

It should be understood, however, that it is also possible for fewer, more and/or other target degree of freedom of movement values DoF-Soll to be present at the virtual driver 314 or at a partially autonomous unit of the vehicle 300. In the case of fully or partially manual control of the vehicle 300 by a human driver, the target degree of freedom of movement value DoF-Soll demanded or desired by the driver can also be determined from a travel of an actuating element. Thus, it is possible, for example, for a target longitudinal deceleration value DoF1-Soll to be determined from a travel of a brake pedal of the vehicle 300 and from a corresponding pedal characteristic.

Via the brake control signals SB, steering control signals SL, and engine control signals SM which it provides on the vehicle network 316, the virtual driver 314 demands vehicle dynamics interventions from the brake system 304, the steering system 318 and the engine 328, these resulting in the target degree of freedom of movement values DoF-Soll. Thus, according to the present embodiment, the brake control unit 312 of the brake system 304 receives, as brake control signal SB, the target longitudinal deceleration value DoF1-Soll of 8 m/s². From this, the brake control unit 312 determines an expected brake pressure value St1-EW, which in this case is an expected manipulated variable value St-EW for the manipulated variable brake pressure pB of the brake system 304. The expected brake pressure value St1-EW is that brake pressure pB that is required, according to a prediction by the brake control unit 312, for achieving the target longitudinal deceleration value DoF1-Soll of 8 m/s². The determining of the expected brake pressure value St1-EW takes place in a manner based on a characteristic map in the present embodiment. In this case, the brake control unit 312 determines an expected brake pressure value St1-EW of 8 bar, corresponding to the target longitudinal deceleration value DoF1-Soll of 8 m/s².

Optimally, a real vehicle behavior of the vehicle 300 (an actual vehicle behavior) corresponds to a desired target vehicle behavior, wherein setting of an expected manipulated variable value St-EW as an actual manipulated variable value St-Ist of a vehicle actuator 302 results in an actual degree of freedom of movement value DoF-Ist which corresponds to the desired target degree of freedom of movement value DoF-Soll. In the present embodiment, ideally, the setting of the expected brake pressure value St1-EW of 8 bar as the actual brake pressure value St1-EW thus results in a longitudinal deceleration of the vehicle 300 of 8 m/s² (actual longitudinal deceleration value DoF1-Ist=8 m/s²). Ideally, the vehicle 300 thus behaves as expected by the virtual driver 314 and the brake control unit 312. For various reasons, however, it is possible for an actual degree of freedom of movement value DoF-Ist to be set that does not correspond to the target degree of freedom of movement value DoF-Soll.

Thus, it is possible, for example, for a performance of a vehicle actuator 302 provided for influencing a degree of freedom of movement DoF to be restricted. In this case, the setting of the expected manipulated variable value St-EW as the actual manipulated variable value DoF-Ist does not result in the desired actual degree of freedom of movement value DoF-Ist or there is a deviation between the actual degree of freedom of movement value DoF-Ist and the target degree of freedom of movement value DoF-Soll. In the embodiment under consideration, it may thus be the case that the setting of the expected brake pressure value St1-EW of 8 bar as the actual brake pressure value St1-Ist does not suffice in order to set the desired longitudinal deceleration DoF1 of the vehicle 300 of 8 m/s². Thus, it is possible, for example, on account of rust that has formed on brake disks, which correspond to the brake cylinders 306, in the course of a relatively long standing time, for it to be necessary to set an actual brake pressure value St1-Ist of 10 bar in order to achieve the target longitudinal deceleration value DoF1-Soll of 3 m/s². In this case, there is thus a performance discrepancy 3 of the vehicle actuator 302 brake system 304. A performance discrepancy should not necessarily be understood, in the present context, as meaning a physical performance with the unit watts, but rather should be understood as meaning the capability to carry out an intended task.

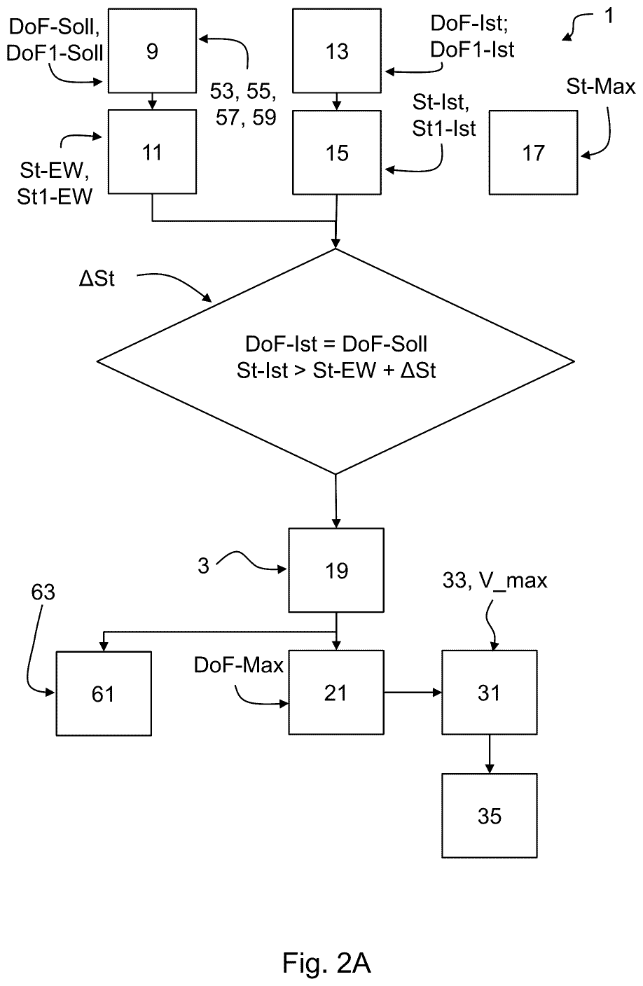

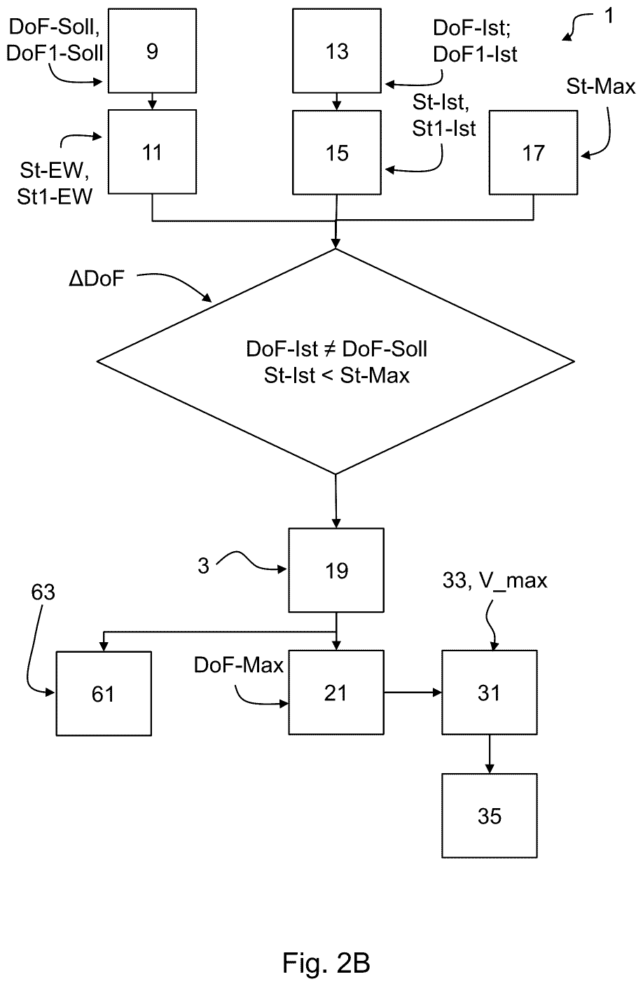

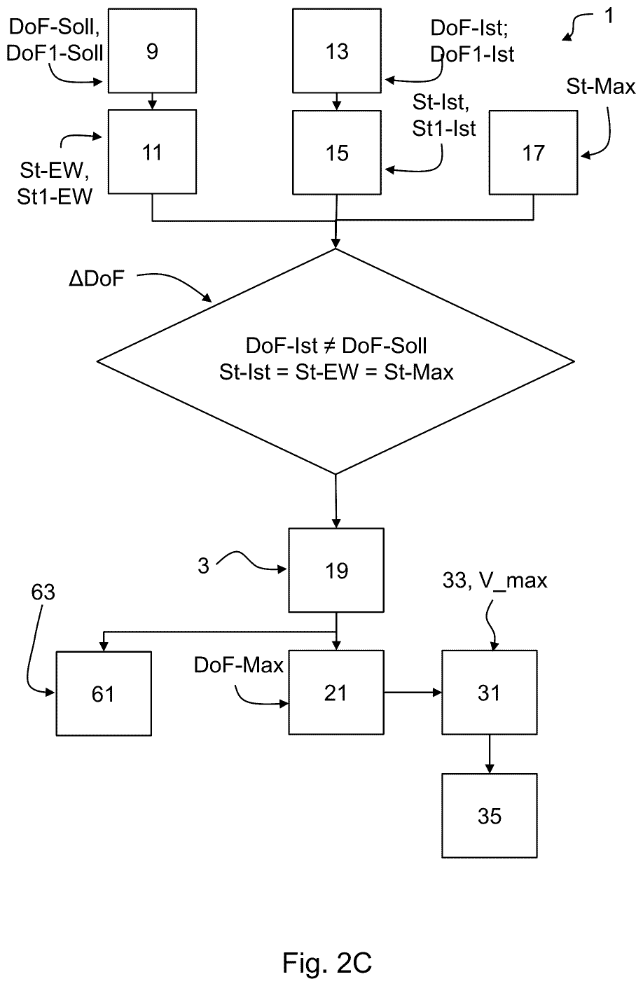

The above-described performance discrepancy 3 of the brake system 304, caused by rust formed over a relatively long standing time, is safety-critical. If the human driver and/or virtual driver 314 of the vehicle 300 is unaware of the performance discrepancy 3, this can result in accidents. Thus, a reduced performance of the brake system 304 may, for example, result in a longer braking distance of the vehicle 300, which may cause accidents. In order to identify performance discrepancies 3 of the vehicle actuators 302, the vehicle 300 has an actuator monitoring system 200. The actuator monitoring system 200 is configured to carry out the method 1, explained below with reference to FIGS. 2 to 4, for determining a performance discrepancy 3 between a target performance and an actual performance of a vehicle actuator 302.

A first step of the method 1 involves determining 9 a target degree of freedom of movement value DoF-Soll. This has already been described above by way of the determining of a target longitudinal deceleration value DoF1-Soll using the trajectory T. Following the determining 9 of the target longitudinal deceleration value DoF1-Soll, a second step of the method 1 involves determining 11 an expected manipulated variable value St-EW. This has also already been explained above as the determining of an expected brake pressure value St1-EW of the brake system 304. It should be understood, however, that, in order to achieve a target degree of freedom of movement value DoF-Soll, it is also possible for a plurality of expected manipulated variable values St-EW of different vehicle actuators 302 to be determined. As further steps, the method 1 includes determining 13 an actual degree of freedom of movement value DoF-Ist for the vehicle 200, this corresponding to the target degree of freedom of movement value DoF-Soll. For the example, described here, of a target longitudinal deceleration value DoF1-Soll, during the determining step 13, an actual longitudinal deceleration value DoF1-Ist of the vehicle 300 in a driving situation is thus determined. The determining 15 of an actual manipulated variable value St-Ist involves determining which manipulated variable St was actually provided at the vehicle actuator 302 in order to set the actual degree of freedom of movement value DoF-Ist. The example under consideration of a longitudinal deceleration DoF1 of the vehicle 300 thus involves, for example, determining which brake pressure pB was provided as the actual manipulated variable value St-Ist (or St1-Ist) at the brake cylinders 306 of the vehicle 300 in order to set an actual longitudinal deceleration value DoF1-Ist as the actual degree of freedom of movement value DoF-Ist.

A further step of the method 1 involves obtaining 17 a maximum manipulated variable value St-Max of the vehicle actuator 208. For the brake system 304, the maximum manipulated variable value St-Max is a maximum brake pressure that can be provided at the brake cylinders 306. For simplification purposes, in the present example, an identical brake pressure pB at all the brake cylinders 306 of the vehicle 300 is considered. It should be understood, however, that it is also possible for individual brake cylinders 306 to be considered.

Steps 9, 11, 13, 15 and 17 take place to some extent simultaneously in the present embodiment. Provision may also be made, however, for individual ones of these steps to be carried out earlier or later than others. Thus, it is possible for the determining 17 of a maximum manipulated variable value St-Max to also take place before the determining 9 of the target degree of freedom of movement value DoF-Soll. Furthermore, it is possible, for example, for the actual manipulated variable value St-Ist to also be determined continuously (the determining 15 can take place continuously), such that the determining 15 can also be carried to some extent before the determining 13 of the actual degree of freedom of movement value DoF-Ist.

The determining of the actual degree of freedom of movement value (DoF-Ist) takes place in this case via a state signal receiving unit 206 of the actuator monitoring system 200. For this purpose, the state signal receiving unit 206 receives corresponding state signals SZ from the vehicle network 316, wherein the state signals SZ representative of the actual degree of freedom of movement value DoF-Ist are provided by the virtual driver 314 on the vehicle network 316 in the embodiment under consideration. The virtual driver 314 determines the actual longitudinal deceleration value DoF1-Ist via different sensors (not illustrated in FIG. 1). However, provision may also be made, for example, for the actual longitudinal deceleration value DoF1-Ist to be determined by an electronic stability control (ESC), wherein the ESC then provides the state signals SZ on the vehicle network 316. Provision may also be made for the state signal receiving unit 206 to determine the actual degree of freedom of movement value DoF-Ist directly by measurement. Furthermore, the state signal receiving unit 206 also receives the actual manipulated variable value St-Ist via the vehicle network 316. Thus, in the embodiment under consideration of a longitudinal deceleration DoF1, the brake control unit 312 provides the actual manipulated variable value St1-EW or corresponding signals continuously on the vehicle network 316.

A target degree of freedom of movement value determining unit 208 of the actuator monitoring system 200 carries out the determining 9 of the target degree of freedom of movement value DoF-Soll. For this purpose, the target degree of freedom of movement value determining unit 208 receives the trajectory T provided by the virtual driver 314 on the vehicle network 316 and determines therefrom one or more target degree of freedom of movement values DoF-Soll. Provision may also be made, however, for the virtual driver 314 to be part of the actuator monitoring system 200, in particular of the target degree of freedom of movement value determining unit 208. Furthermore, the target degree of freedom of movement value determining unit 208 also determines, on the basis of signals from the vehicle network 316, the expected manipulated variable value St-EW, wherein this takes place by evaluation of signals from the brake control unit 312 in the embodiment under consideration.

Furthermore, the actuator monitoring system 200 includes a performance discrepancy determining unit 210 which determines the performance discrepancy 3 of the vehicle actuator 302 under consideration. The state signal receiving unit 206, the target degree of freedom of movement value determining unit 208 and the performance discrepancy determining unit 310 are in this case subunits of a monitoring control unit 202 of the actuator monitoring system 200, but may also be embodied as separated units. Thus, it is possible, for example, for the target degree of freedom of movement value determining unit 208 to also be formed by the virtual driver 314. Furthermore, the monitoring control unit 202 includes an interface 204 connected to the vehicle network 316.

The determining 9 of the target degree of freedom of movement value DoF-Soll, the determining 11 of the expected manipulated variable value St-EW, the determining 13 of the actual degree of freedom of movement value DoF-Ist, the determining 15 of the actual manipulated variable value St-Ist, and the obtaining 17 of the maximum manipulated variable value St-Max are followed, in the method 1, by the determining 19 of the performance discrepancy 3 of the vehicle actuator 302, if one of three conditions that are explained below with reference to FIGS. 2A to 2C is fulfilled.

In a first case, a performance discrepancy 3 is determined by the performance discrepancy determining unit 210 of the actuator monitoring system 200 when the actual degree of freedom of movement value DoF-Ist corresponds to the target degree of freedom of movement value DoF-Soll, but an actual manipulated variable value St-Ist required for setting this actual degree of freedom of movement value DoF-Ist is higher than the previously determined expected manipulated variable value St-EW. In the embodiment, under consideration here, of longitudinal deceleration DoF1 of the vehicle 300, the target longitudinal deceleration value DoF1-Soll of 8 m/s² is thus achieved in this case, but a brake pressure St1-Ist of 10 bar rather than the expected brake pressure value St1-EW of 8 bar has to be provided at the brake cylinders 206 of the brake system 304 for this purpose. In the first case, illustrated in FIG. 2A, of determining 19 the performance discrepancy 3, the desired vehicle movement is thus achieved, but the vehicle actuator 304 has to be actuated more strongly than predicted for this purpose. This is the case, for example, when brake pads assigned to the brake cylinders 306 overheat. The virtual driver 314 acting as a position control unit identifies small deviations between the target degree of freedom of movement value DoF-Soll and the actual degree of freedom of movement value DoF-Ist and adjusts the brake control signals SB, or, with the aid of the brake control unit 312, the brake pressure pB, accordingly, such that, overall, the target longitudinal deceleration value DoF1-Soll is reached as the actual longitudinal deceleration value DoF1-Ist.

In order to prevent erroneous determinations, the determining 19 of the performance discrepancy 3 takes place, however, only when the actual manipulated variable value St-Ist lies outside a manipulated variable tolerance ΔSt around the expected manipulated variable value St-EW. This makes it possible to prevent minor measurement inaccuracies that occur for example when determining the actual manipulated variable value St-Ist from resulting in the determining 19 of a performance discrepancy 3.

The determining 19, illustrated in FIG. 2A, of the performance discrepancy 3 is a case that arises frequently in practice, in which, although the desired vehicle behavior can be set, a performance of one or more vehicle actuators 302 is undesirably reduced. FIG. 2B and FIG. 2C, by contrast, illustrate cases in which the desired vehicle behavior of the vehicle 300 cannot be set or in which the actual degree of freedom of movement value DoF-Ist deviates from the target degree of freedom of movement value DoF-Soll. In the embodiment under consideration, this is the case, for example, when, rather than the target longitudinal deceleration value DoF1-Soll of 8 m/s², only a maximum actual longitudinal deceleration value DoF1-Ist of 4 m/s² is achieved. This deviation between the target longitudinal deceleration value DoF1-Soll and the actual longitudinal deceleration value DoF1-Ist may have various causes.

In a second case (FIG. 2B) of determining 19 the performance discrepancy 3, the actual degree of freedom of movement value DoF-Ist deviates from the target degree of freedom of movement value DoF-Soll and the actual manipulated variable value is lower than the maximum manipulated variable value St-Max. For the longitudinal deceleration DoF1 under consideration, a value of 4 m/s² rather than the desired target longitudinal deceleration value DoF1-Soll of 8 m/s² is thus achieved and the brake pressure pB is below the maximum brake pressure pB_max of 10 bar. The virtual driver 314 and also a human driver will, when the vehicle 300 is decelerated less than desired (DoF1-Ist≤DoF1-Soll), demand an additional brake performance from the brake system 304. This may not be possible, however, for various reasons, for example if, on account of leaks in the brake system 304, only a brake pressure pB of 8 bar rather than maximum brake pressure, according to the configuration, of 10 bar is settable. Therefore, if there is a performance discrepancy 3 of the vehicle actuator 302, the target degree of freedom of movement value DoF-Soll can then deviate from the actual degree of freedom of movement value DoF-Ist and so the performance discrepancy 3 can be determined. In order to compensate for measurement inaccuracies, the determining 19 of the performance discrepancy takes place in the second case only when the actual degree of freedom of movement value DoF-Ist deviates from the target degree of freedom of movement value DoF-Soll by more than a degree of freedom of movement tolerance ΔDoF.

In a third case (cf. FIG. 2C) the determining 19 of a performance discrepancy 3 takes place when the actual degree of freedom of movement value DoF-Ist deviates from the target degree of freedom of movement value DoF-Soll even though the actual St value St-Ist is equal to the expected manipulated variable value St-EW and equal to the maximum manipulated variable value St-Max. Thus, in the present embodiment, upon emergency braking of the vehicle 300, in spite of the maximum brake pressure pB of 10 bar being set, an actual longitudinal deceleration value DoF1-Ist is achieved that is lower than the target longitudinal deceleration value DoF1-Soll. This is the case, for example, when the brake system 304 of the vehicle 300 can no longer provide the full deceleration performance on account of overheated brake disks and brake pads.

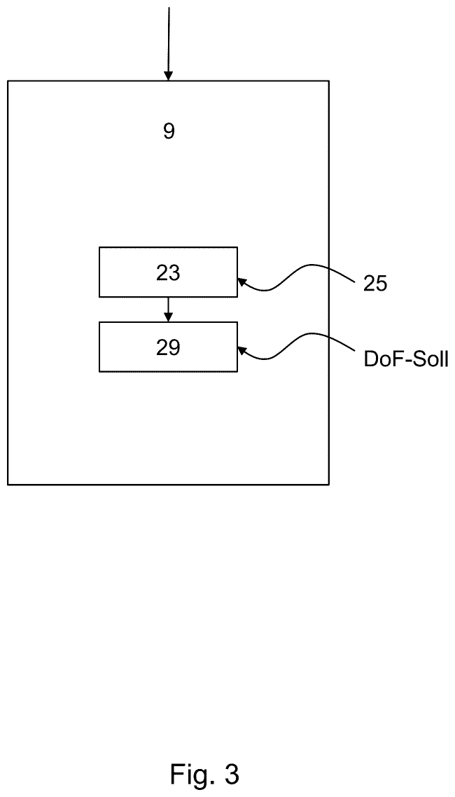

Apart from the determining step 19 and the conditions to be fulfilled in that regard, the method according to FIGS. 2A to 2C is identical, and so the following description applies analogously to all three cases of determining 19 the performance discrepancy 3. Analogously, the determining steps 9, 11, 13, 15 and obtaining step 17 in the method 1 according to FIGS. 2A to 2C are substantially identical. In the present embodiment, the determining 9 of the target degree of freedom of movement value DoF-Soll takes place on the basis of the trajectory T, wherein, first of all, the trajectory T for the vehicle 300 is determined by the virtual driver 314 (determining step 23 in FIG. 3) and then the target degree of freedom of movement value DoF-Soll, as has already been described, is determined on the basis of the trajectory T (determining step 29 in FIG. 3).

As a result of the target degree of freedom of movement value DoF-Soll, the actual degree of freedom of movement value DoF-Ist, the expected manipulated variable value St-EW, the actual manipulated variable value St-Ist, and the maximum manipulated variable value St-Max being considered, it is possible, in the method 1 according to invention, to determine a performance discrepancy 3 of a vehicle actuator 304. Following this determining 19 of the performance discrepancy 3, the determining 21 of an updated maximum degree of freedom of movement value DoF-Max, on the basis of the determined performance discrepancy 3, also takes place in the method 1. The performance discrepancy 3 is thus used to update a maximum degree of freedom of movement value DoF-Max of the vehicle 300. Thus, it is possible, for example, for a maximum longitudinal deceleration value DoF1-Max of the vehicle 300, given a fully functional brake system 304, to have a value of 10 m/s². On account of rust on brake disks assigned to the brake cylinders 306, it is possible, however, for there to be a performance discrepancy 3 of the brake system 3, such that, under certain circumstances, a longitudinal deceleration DoF1 of the vehicle 300 of only 6 m/s² can be achieved. This updated longitudinal deceleration DoF1 is set, as part of the determining step 21, as an updated maximum degree of freedom of movement value DoF-Max. The updated maximum degree of freedom of movement value DoF-Max can then be used further for controlling the vehicle 300.

Thus, the method 1 shown in FIGS. 2A to 2C includes the determining 31 of a vehicle dynamics limit value 33 for the vehicle 300. The vehicle dynamics limit value 33 is determined on the basis of the updated maximum degree of freedom of movement value DoF-Max. Thus, it is possible for the vehicle dynamics limit value 33, in the simplest case, to be a maximum demandable longitudinal deceleration DoF1 of the vehicle 300. In this case, however, the vehicle dynamics limit value 33 is a maximum speed V_max, which cannot be exceeded by the vehicle 300. Thus, the maximum speed V_max of the vehicle 300 can be limited, for example, to a value of 50 km/h when a performance discrepancy 3 of the brake system 304 is determined. Particularly preferably, the vehicle dynamics limit value 33 scales up with the determined performance discrepancy 3. Thus, for example, a maximum speed V_max of 70 km/h may be possible when the brake system 304 can provide a longitudinal deceleration DoF1 of the vehicle 300 of 6 m/s², and a maximum speed V_max of only 30 km/h when the brake system 304 is capable or providing a longitudinal deceleration DoF1 of the vehicle 300 of 3 m/s².

Furthermore, the method 1, in the embodiments shown, involves redetermining 35 the planned trajectory T using the determined vehicle dynamics limit value 33. For this purpose, the actuator monitoring system 200 provides the vehicle dynamics limit value 33 on the vehicle network 316 via the interface 204. The virtual driver 314 receives the vehicle dynamics limit value 33 and plans the trajectory T anew, wherein the trajectory T complies with the determined maximum speed V_max. During the redetermining 35 of the trajectory T, it is also possible, however, rather than a full redetermination, to update the trajectory T. Thus, for example, the path P can be maintained and only the associated speed profile adapted.

Furthermore, the method 1, in the embodiments shown, includes providing 61 a warning signal 63 if a performance discrepancy 3 of the vehicle actuator 304 is determined. In this case, the warning signal 63 is a digital signal which the actuator monitoring system 200 provides on the vehicle network 316 via the interface 204. Furthermore, however, the warning signal 63 also includes a visual and acoustic warning signal 63 which is provided at a human-machine interface 332 in a cockpit (not illustrated in the figures) of the vehicle 300. Thus, a human passenger can be informed of the performance discrepancy and can optionally take over control of the vehicle 300 from the virtual driver 314.

As the above explanations show, the method 1 preferably uses only vehicle onboard data for determining 11, 15 the expected manipulated variable value St-EW and the actual manipulated variable value St-Ist. It is also possible for the target degree of freedom of movement value DoF-Soll and/or the actual degree of freedom of movement value DoF-Ist to be determined only on the basis of vehicle onboard data. Thus, the actual longitudinal deceleration value DoF1-Ist can be determined, for example, via an acceleration sensor and without GPS data. It is also possible for the determining 9 of the target degree of freedom of movement value DoF-Soll to be carried out without external data or only with vehicle onboard data. The virtual driver 314 then preferably uses no external map data to determine the trajectory T. Provision may also be made, however, for one of the determining steps 9, 11, 13, 15 to take place using vehicle-external data but without external map data.

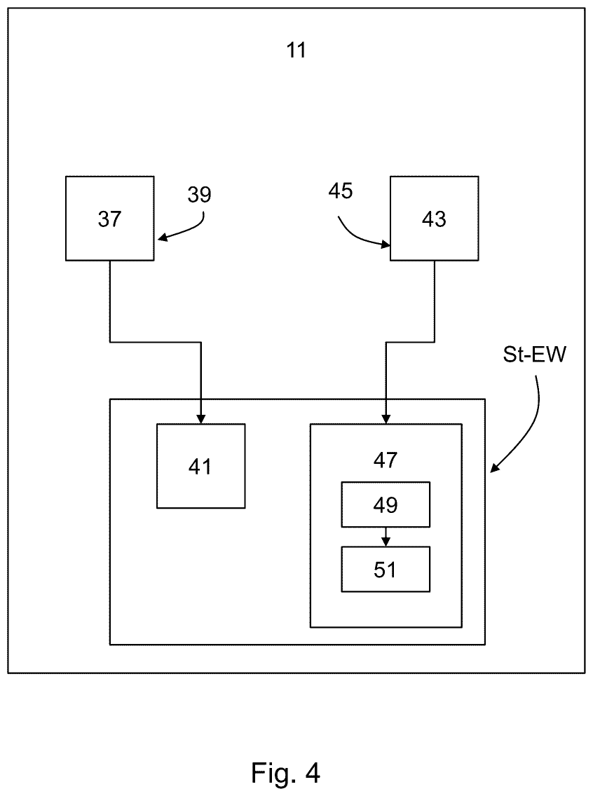

The determining 11 of the expected manipulated variable value St-EW of the vehicle actuator 302 is illustrated in more detail in FIG. 4. Thus, the determining step 11 in the present embodiment takes place by determining 37 environmental data 39 of the vehicle 200. These environmental data 39, for example weather data or gradient information, are then taken into consideration when determining 41 the expected manipulated variable value St-EW. Thus, it is possible, for example, in the method 1 to take into account the fact that, on account of a downhill section, a greater brake pressure pB has to be set than on the level. Furthermore, the determining 11 of the expected manipulated variable value St-EW also includes determining 47 the expected manipulated variable value St-EW, which takes place using vehicle data 45 that are determined in a previous step for a current vehicle configuration 301 of the vehicle 300 (determining step 43 in FIG. 4). In the embodiment shown, therefore, both environmental data 39 and vehicle data 45 are taken into consideration for determining 11 the expected manipulated variable value St-EW.

The determining 47 of the expected manipulated variable value St-EW using vehicle data 45 serves to take into account current conditions of the vehicle 300. Thus, the vehicle data 45 of the current vehicle configuration 301 preferably also include load information relating to loading of the vehicle. Thus, a deceleration performance of the vehicle 300 may, for example, also be impaired (or there may be a performance discrepancy 3 of the brake system 304) if the vehicle 300 is overloaded. When determining 47 the expected manipulated variable value St-EW using vehicle data 45, in the embodiment shown, first of all a dynamic behavior of the vehicle 300 in the current vehicle configuration 31 is predicted (predicting step 49 in FIG. 4) and subsequently the expected manipulated variable value St-EW is determined on the basis of the predicted dynamic behavior of the vehicle 300 (determining step 51 in FIG. 4). The predicting 49 can take place, for example, using a vehicle model, in particular a single-track model, of the vehicle 300. Accuracy of the method 1 is improved.

It should be understood that the method 1 for determining the performance discrepancy 3 for different vehicle actuators 302 than the brake system 304 can take place substantially analogously. In particular a performance discrepancy 3 of another vehicle actuator 302 can also take place at the same time. In this case, some determining steps may also overlap.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

1 Method
3 Performance discrepancy
9 Determining of a target degree of freedom of movement value
11 Determining of an expected manipulated variable value
13 Determining of an actual degree of freedom of movement value
15 Determining of an actual manipulated variable value
17 Obtaining of a maximum manipulated variable value
19 Determining of a performance discrepancy
21 Determining of an updated maximum degree of freedom of movement value
23 Determining of a planned trajectory
29 Determining of the target degree of freedom of movement value on the basis of a trajectory
31 Determining of a vehicle dynamics limit value
33 Vehicle dynamics limit value
35 Redetermining of a trajectory
37 Determining of environmental data
39 Environmental data
41 Determining of the expected manipulated variable value using environmental data
43 Determining of vehicle data
45 Vehicle data
47 Determining of the expected manipulated variable value using vehicle data
49 Predicting of a dynamic vehicle behavior
51 Determining of the expected manipulated variable value on the basis of predicted dynamic properties
61 Providing of a warning signal
63 Warning signal
200 Actuator monitoring system
202 Monitoring control unit
204 Interface
206 State signal receiving unit
208 Target degree of freedom of movement value determining unit
210 Performance discrepancy determining unit
300 Vehicle
301 Current vehicle configuration
302 Vehicle actuators
304 Brake system
306, 306a, 306b,
306c, 306d Brake cylinders
308 Wheels
308a, 308b Front wheels
308c, 308d Rear wheels
310 Brake modulator
312 Brake control unit
314 Autonomous unit; virtual driver
316 Vehicle network
318 Electronically controllable steering system
320 Steering control unit
322 Steering shaft
324 Servomotor
326 Roadway
328 Engine
330 Engine control device
332 Human-machine interface
DoF Degree of freedom of movement
DoF1 Longitudinal deceleration
DoF2 Lateral acceleration
DoF3 Yaw rate
DoF4 Longitudinal acceleration
DoF-Ist Actual degree of freedom of movement value
DoF1-Ist Actual longitudinal deceleration value
DoF-Max Maximum degree of freedom of movement value
DoF-Soll Target degree of freedom of movement value
DoF1-Soll Target longitudinal deceleration value
ΔDoF Degree of freedom of movement tolerance
M Drive torque
P Path
SB Brake control signals
SL Steering control signals
SM Engine control signals
St-EW Expected manipulated variable value
St1-EW Expected brake pressure value
St-Ist Actual manipulated variable value
St1-Ist Actual brake pressure value
St2 Injected quantity
St3 Servo current
ΔSt Manipulated variable tolerance
SZ State signal
T Trajectory
V Speed
V_max Maximum speed
δ Steering angle

1. A method for determining a performance discrepancy between a target performance and an actual performance of a vehicle actuator of a vehicle, wherein the vehicle actuator is configured to influence at least one degree of a freedom of movement of a vehicle, the method comprising:
determining a target degree of a freedom of movement value for the vehicle;
determining an expected manipulated variable value for achieving the target degree of the freedom of movement value;
determining an actual degree of the freedom of movement value for the vehicle, wherein the actual degree of the freedom of movement value corresponds to the target degree of the freedom of movement value;
determining an actual manipulated variable value which is provided at the vehicle actuator for achieving the actual degree of the freedom of movement value;
obtaining a maximum manipulated variable value of the vehicle actuator; and,
determining the performance discrepancy of the vehicle actuator if:
the actual degree of the freedom of movement value lies outside a degree of a freedom of movement tolerance around the target degree of the freedom of movement value and the actual manipulated variable value is lower than the maximum manipulated variable value;
the actual degree of the freedom of movement value lies outside a degree of the freedom of movement tolerance around the target degree of the freedom of movement value, an expected manipulated variable value corresponds to the maximum manipulated variable value, and the actual manipulated variable value corresponds to the maximum manipulated variable value; or
the actual degree of the freedom of movement value corresponds to the target degree of the freedom of movement value and the actual manipulated variable value required for achieving the actual degree of the freedom of movement value lies outside a manipulated variable tolerance around the expected manipulated variable value; and,
determining an updated maximum degree of the freedom of movement value of the vehicle on a basis of the determined performance discrepancy.

2. The method of claim 1, wherein said determining of the performance discrepancy of the vehicle actuator takes place only:
if the actual degree of the freedom of movement value lies outside a degree of the freedom of movement tolerance around the target degree of the freedom of movement value for at least a discrepancy time; or,
if the actual manipulated variable value required for achieving the target degree of the freedom of movement value lies outside the manipulated variable tolerance around the expected manipulated variable value for at least the discrepancy time.

3. The method of claim 1, wherein said determining of the target degree of the freedom of movement value includes:
determining a planned trajectory for the vehicle, via an autonomous unit; and,
determining the target degree of the freedom of movement value from the trajectory.

4. The method of claim 1 further comprising determining a vehicle dynamics limit value for the vehicle via the determined performance discrepancy, if the performance discrepancy of the vehicle actuator is determined.

5. The method of claim 3 further comprising:
determining a vehicle dynamics limit value for the vehicle via the determined performance discrepancy, if the performance discrepancy of the vehicle actuator is determined; and,
redetermining the planned trajectory via the determined vehicle dynamics limit value.

6. The method of claim 1, wherein said determining of the expected manipulated variable value of the vehicle actuator for achieving the target degree of the freedom of movement value takes place via learned actual manipulated variable values for a learned target degree of the freedom of movement values which lie in a degree of a freedom of movement tolerance band around the target degree of the freedom of movement value.

7. The method of claim 1, wherein said determining of the expected manipulated variable value of the vehicle actuator for achieving the target degree of the freedom of movement value includes:
determining environmental data of the vehicle; and,
determining the expected manipulated variable value via the environmental data.

8. The method of claim 1, wherein said determining of the expected manipulated variable value of the vehicle actuator for achieving the target degree of the freedom of movement value includes:
determining vehicle data of a current vehicle configuration of the vehicle; and,
determining the expected manipulated variable value via the vehicle data.

9. The method of claim 8, wherein said determining of the expected manipulated variable value via the vehicle data includes:
predicting a dynamic behavior of the vehicle via the vehicle data; and,
determining the expected manipulated variable value on a basis of the predicted dynamic behavior of the vehicle.

10. The method of claim 1, wherein the degree of the freedom of movement is or includes at least one of a longitudinal acceleration of the vehicle, a longitudinal deceleration of the vehicle, a maximum curvature of a path that is maximally drivable by the vehicle, a steering angle speed of the vehicle, a steering angle of the vehicle, and a yaw speed of the vehicle.

11. The method of claim 1, wherein the vehicle actuator includes at least one of an active steering system, a brake system, a parking brake, a sustained-action brake, a driving brake, a wheel locking mechanism, an additional steering system, an internal combustion engine, and an electric motor of the vehicle.

12. The method of claim 1, wherein said determining of the performance discrepancy takes place via a brake system of the vehicle.

13. The method of claim 1 further comprising providing a warning signal if a performance discrepancy of the vehicle actuator is determined.

14. The method of claim 13, wherein the warning signal is provided via a human-machine interface.

15. The method of claim 1, wherein the target degree of the freedom of movement value is determined on a basis of vehicle onboard data.

16. An actuator monitoring system for monitoring a performance characteristic of a vehicle actuator configured to influence at least one degree of a freedom of movement of a vehicle, the actuator monitoring system comprising:
a state signal receiving unit which is connectable to a network of the vehicle in order to receive state signals that represent an actual degree of a freedom of movement value of the vehicle, and which is connectable to the vehicle actuator in order to receive an actual manipulated variable value;
a target degree of a freedom of movement value determining unit configured to determine a target degree of the freedom of movement value for the vehicle and an expected manipulated variable value of the vehicle actuator for achieving the target degree of the freedom of movement value;
a performance discrepancy determining unit configured to determine a performance discrepancy of the vehicle actuator if:
the actual degree of the freedom of movement value lies outside a degree of a freedom of movement tolerance around the target degree of the freedom of movement value and the actual manipulated variable value is lower than a maximum manipulated variable value;
the actual degree of the freedom of movement value lies outside a degree of the freedom of movement tolerance around the target degree of the freedom of movement value, the expected manipulated variable value corresponds to the maximum manipulated variable value, and the actual manipulated variable value corresponds to the maximum manipulated variable value; or,
the actual degree of the freedom of movement value corresponds to the target degree of the freedom of movement value and the actual manipulated variable value required for achieving the actual degree of the freedom of movement value lies outside a manipulated variable tolerance around the expected manipulated variable value; and,
said performance discrepancy determining unit being configured to determine an updated maximum degree of the freedom of movement value of the vehicle on a basis of the determined performance discrepancy.

17. A vehicle comprising:
a vehicle actuator;
a network;
an actuator monitoring system for monitoring a performance characteristic of said vehicle actuator configured to influence at least one degree of a freedom of movement of the vehicle;
said actuator monitoring system including a state signal receiving unit, a target degree of a freedom of movement value determining unit, and a performance discrepancy determining unit;
said state signal receiving unit being connectable to said network in order to receive state signals that represent an actual degree of a freedom of movement value of the vehicle, and which is connectable to said vehicle actuator in order to receive an actual manipulated variable value;
said target degree of the freedom of movement value determining unit being configured to determine a target degree of the freedom of movement value for the vehicle and an expected manipulated variable value of said vehicle actuator for achieving the target degree of the freedom of movement value;
a performance discrepancy determining unit configured to determine a performance discrepancy of said vehicle actuator if:
the actual degree of the freedom of movement value lies outside a degree of a freedom of movement tolerance around the target degree of the freedom of movement value and the actual manipulated variable value is lower than a maximum manipulated variable value;
the actual degree of the freedom of movement value lies outside a degree of the freedom of movement tolerance around the target degree of the freedom of movement value, the expected manipulated variable value corresponds to the maximum manipulated variable value, and the actual manipulated variable value corresponds to the maximum manipulated variable value; or,
the actual degree of the freedom of movement value corresponds to the target degree of the freedom of movement value and the actual manipulated variable value required for achieving the actual degree of the freedom of movement value lies outside a manipulated variable tolerance around the expected manipulated variable value; and,
said performance discrepancy determining unit being configured to determine an updated maximum degree of the freedom of movement value of the vehicle on a basis of the determined performance discrepancy; and,
said actuator monitoring system being connected to said network in order to receive actual value data representative of the actual degree of the freedom of movement value.
